(19) United States
(12) Patent Application Publication
(10) Pub. No.: US 2026/0216586 A1
(43) Pub. Date: Jul. 30, 2026

(54) BUTT OF A BILLIARD CUE

(71) Applicant: JUNG-SHIH CHANG, TAICHUNG CITY (TW)

(72) Inventor: JUNG-SHIH CHANG, TAICHUNG CITY (TW)

(21) Appl. No.: 19/060,397

(22) Filed: Feb. 21, 2025

(30) Foreign Application Priority Data
Jan. 24, 2025 (CN) 202510115101.1

(51) Int. Cl. A63D 15/08; B32B 1/00; B32B 5/12

(52) U.S. Cl. CPC A63D 15/08; B32B 1/00; B32B 5/12; B32B 2260/023; B32B 2260/046; B32B 2262/101; B32B 2262/106

(57) ABSTRACT

A butt of a billiard cue includes a tubular body made of FRP, a damping member, a weight adjustment system, and a shock-absorbing layer. The tubular body has a hollow core and a central axis. The damping member is filled within the hollow core. The weight adjustment system includes a tubular member fixed within the hollow core and a weight device screwed into the tubular member. The shock-absorbing layer is positioned on the outer surface of the tubular body. Additionally, the tubular body includes a first unidirectional fiber fabric layer, which facilitates force transmission along the axis, and a second unidirectional fiber fabric layer bonded to the first layer to prevent displacement during the manufacturing process.

### BACKGROUND OF THE INVENTION

### 1. Field of the Invention

The disclosure relates to billiard cues, and particularly to a butt of a billiard cue.

### 2. Description of the Related Art

Currently, commercially available billiard cues typically consist of two main parts: the shaft and the butt, which are connected by a joint. The shaft is primarily responsible for making contact with the cue ball and controlling its direction, while the butt serves as the grip area for the user and transmits the striking force to the shaft, thereby influencing the speed and direction of the cue ball's movement. Taiwan Utility Model Patent No. M563904U discloses an improved butt. The butt comprises a core rod, an intermediate component fitted around the core rod, and a covering body enclosing the intermediate component. The covering body includes multiple elongated connecting members arranged around the axis of the core rod. This design enhances cue ball control stability and reduces the shaft's rigidity. However, its drawbacks include the tendency to generate noise and vibration during striking, as well as the inability to adjust the cue's center of gravity. Similarly, Chinese Utility Model Patent No. CN214861116U introduces another improved butt, which enhances the bending resistance of the butt by embedding multiple carbon fiber strips into a maple wood core. However, this structure also generates noise and vibration during striking and still does not allow for the adjustment of the cue's center of gravity. Furthermore, U.S. Pat. No. 6,736,733 discloses an improved billiard cue, in which at least one section of the cue shaft consists of an outer shell made of fiber-reinforced plastic, an internal filling of plastic foam material, and an outer wooden layer. This design aims to mitigate the issues of deformation and aging commonly associated with wooden materials while also absorbing impact vibrations during striking. However, because the shaft and the butt share the same structural design, it still fails to effectively address the noise and vibration issues during striking and does not allow for the adjustment of the cue's center of gravity. Moreover, Chinese Invention Patent No. ZL 2018 1 1016551.1 focuses on improving the shaft of a billiard cue. This shaft comprises a tubular shell made of fiber-reinforced plastic and a foam core. The tubular shell further includes a first fiber bundle aligned parallel to its longitudinal axis and a second fiber bundle arranged perpendicular to the longitudinal axis. This structure effectively enhances shot stability and accuracy while reducing noise and vibration. However, this patent only improves the shaft and does not address any improvements to the butt.

### SUMMARY OF THE INVENTION

Through in-depth research, the inventor has discovered that the butt and the shaft of a billiard cue serve significantly different functions. In the aforementioned prior art, if the materials and structure of the butt were further improved, it could not only help users achieve a more stable feel during the stroke—such as by reducing excessive high-frequency vibrations and noise while providing a more comfortable hitting experience—but also ensure consistency in force, angle, and speed when striking the ball. Furthermore, a well-designed butt structure can effectively absorb the vibrations and impact forces generated during a shot, not only reducing hand discomfort but also improving the overall playing experience. Additionally, an optimally balanced butt can further assist users in achieving a more stable and controlled stroke, thereby enhancing shot accuracy and precision.

Thus, in one aspect of the present disclosure, the aforementioned deficiencies are mitigated by utilizing an improved butt. In a preferred embodiment of the present disclosure, the improved butt comprises a tubular body made of FRP, a hollow core, and an axis extending along its length. It includes at least a first unidirectional fiber fabric layer for transmitting force along the axis and at least a second unidirectional fiber fabric layer bonded to the first layer to prevent shifting during the manufacturing process. This tubular body replaces conventional wood to address the shortcomings of wooden materials, such as the lack of unidirectional grain, uneven density distribution, and the inability to adjust hardness and softness. Furthermore, to effectively absorb the vibrations, impact forces, and noise generated during a shot, the improved butt includes a damping member filled within the hollow core. This damping member is made of plastic foam, such as PU foam with a predetermined density. Additionally, the outer surface of the tubular body may be covered with a shock-absorbing layer, such as a wooden surface layer, to further enhance vibration absorption, reduce energy transmission and noise generation, and ultimately improve the user's stroke feel and overall playing experience. Additionally, the improved butt further includes a weight adjustment system comprising a tubular member and at least a weight device. The tubular member is securely fixed within the hollow core and has an internally threaded surface. The weight device, which has an externally threaded surface, is screwed into the tubular member, allowing for precise positional adjustment within the hollow core. This design enables quick and easy modification of the cue's center of gravity.

To more accurately convey the user's forward cueing force, in another aspect of the present disclosure, the first unidirectional fiber fabric layer includes a plurality of fibers extending in a direction parallel to the axis. The second unidirectional fiber fabric layer includes a plurality of fibers extending in a direction perpendicular to the axis.

In another preferred embodiment of the present disclosure, the tubular body comprises an upper fiber fabric layer region near its surface and a lower fiber fabric layer region near its central axis. The first and second unidirectional fiber fabric layers in the upper region can be made of unidirectional carbon fiber fabric, while those in the lower region are made of unidirectional glass fiber fabric. Alternatively, the upper region may use unidirectional glass fiber fabric, while the lower region is made of unidirectional carbon fiber fabric. By optimizing the material properties of each region, this design effectively enhances the rigidity, toughness, and vibration transmission characteristics of the butt while reducing production costs, thereby meeting the diverse needs of users.

To prevent the first unidirectional fiber fabric layer disposed on the surface of the tubular body from wearing during the manufacturing process, another preferred embodiment of the present disclosure provides that the tubular body further comprises at least a fiber fabric set on its surface. The fiber fabric set includes two first unidirectional fiber fabric layers bonded together.

### BRIEF DESCRIPTION OF THE DRAWINGS

Other features and advantages of the disclosure will become readily apparent to those skilled in the art from the following detailed description of the embodiments in the light of the accompanying drawings, in which:

FIG. 1 is a side view of a billiard cue, in which the butt is a preferred embodiment of the present disclosure;

FIG. 2 is a cross-sectional view taken along the direction 2-2 of FIG. 1;

FIG. 3 is a cross-sectional view taken along the direction 3-3 of FIG. 1;

FIG. 4 is a partially cutaway perspective view of the butt shown in FIG. 1;

FIG. 5 is a partial exploded view of the butt shown in FIG. 1; and

FIG. 6 is a partially cutaway perspective view of another preferred embodiment of the present disclosure.

### DETAILED DESCRIPTION OF THE INVENTION

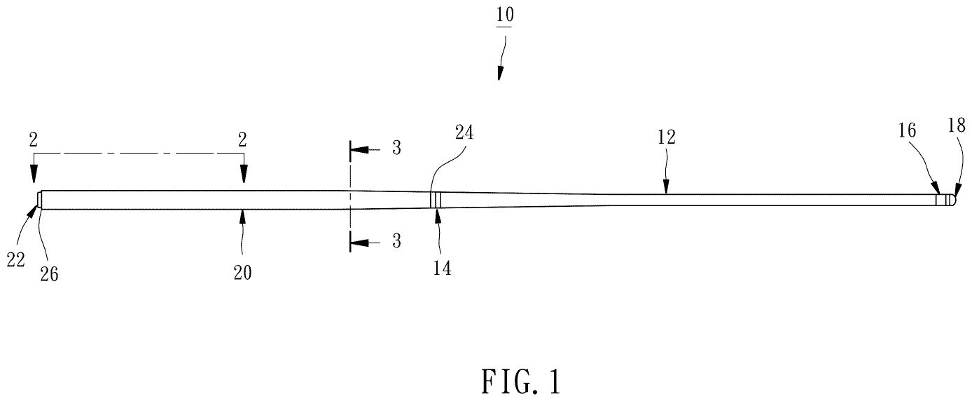

Referring first to FIG. 1, a side view of a billiard cue 10 is illustrated. The billiard cue 10 comprises a shaft 12 and a butt 20, which are joined using a conventional fixing method. For example, the shaft 12 is securely connected to the butt 20 via a threaded joint 14. The butt 20 is a preferred embodiment of the present disclosure. As shown in FIG. 1, the top end of the shaft 12 is fitted with a ferrule 16 and a cue tip 18, while the bottom end of the butt 20 is equipped with a bumper 22. The shaft 12 primarily serves as the contact point with the cue ball, whereas the butt 20 is the section gripped by the user to transmit striking force through the shaft 12, ultimately impacting the cue ball.

The total length of the billiard cue 10 is approximately 1450 mm. The shaft 12 typically constitutes about two-thirds of the total length, measuring between 910 mm and 1020 mm, while the butt 20 accounts for the remaining one-third, ranging from 430 mm to 530 mm. The butt 20 gradually increases in diameter from the front end 24 to the rear end 26. In this embodiment, the outer diameter of the front end 24 is approximately 22 mm, while that of the rear end 26 is around 31 mm.

Currently, most commercially available billiard cue butts are made of wood. However, wooden butts have several drawbacks. For instance, wood is prone to expansion and contraction due to fluctuations in environmental humidity and temperature, which can lead to cue deformation, loosened joints, or even warping, cracking, and aging over time. Additionally, wood has inherent limitations in strength and hardness, making it susceptible to dents and damage from accidental impacts. Furthermore, natural variations in wood grain and internal defects may introduce inconsistencies during manufacturing, affecting the cue's structural stability and overall performance. More critically, the widespread use of wood contributes to deforestation, habitat destruction, and ecological imbalances, posing significant environmental concerns.

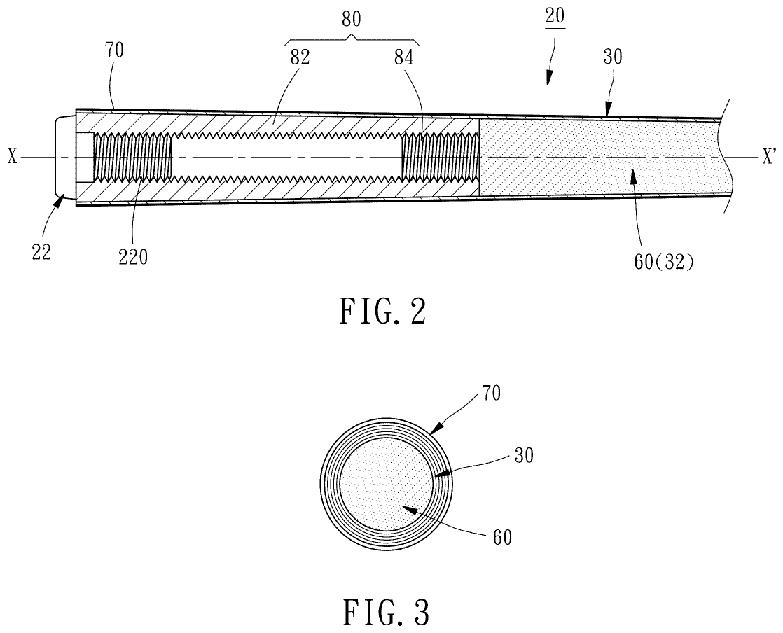

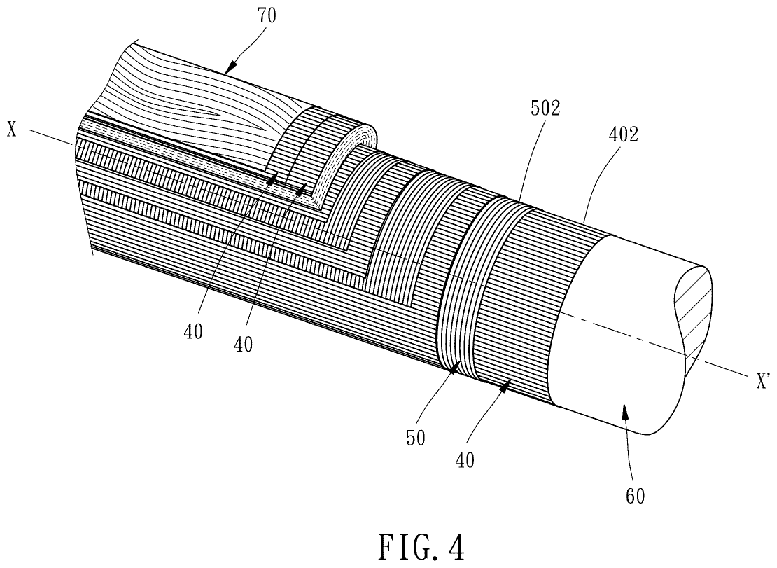

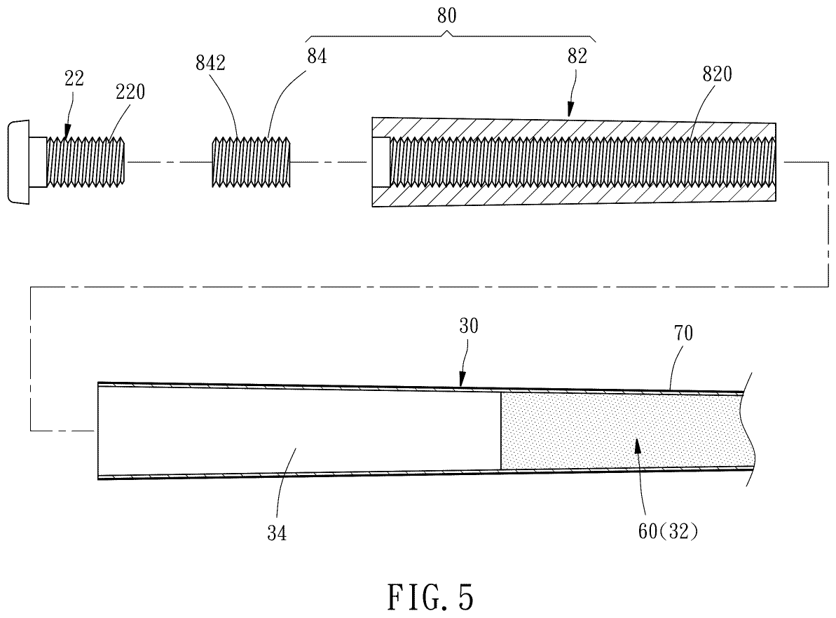

To overcome the aforementioned drawbacks of wooden cue butts, the butt 20, as shown in FIGS. 2-5, comprises a cylindrical tubular body 30, which is formed by multiple sequentially laminated layers of fiber-reinforced plastic (FRP). More specifically, the tubular body 30 includes a plurality of first unidirectional fiber fabric layers 40, which transmit force along the axis of the butt 20, and a plurality of second unidirectional fiber fabric layers 50. Each second unidirectional fiber fabric layer 50 is bonded to a corresponding first unidirectional fiber fabric layer 40 to prevent interlayer displacement during manufacturing. In this embodiment, the butt 20 further comprises a hollow core 32 and defines a central axis X-X′ along its length. Each first unidirectional fiber fabric layer 40 includes multiple fibers 402 aligned parallel to the axis X-X′. In contrast, each second unidirectional fiber fabric layer 50 includes multiple fibers 502 aligned perpendicular to the axis X-X′. If the first and second unidirectional fiber fabric layers 40 and 50 are made of carbon fiber fabric, each layer has a thickness of approximately 0.09 mm. If they are made of glass fiber fabric, each layer has a thickness of approximately 0.11 mm. If the cylindrical tubular body 30 has a wall thickness of 2.0 mm, the total layer count ranges from approximately 17 to 23. Additionally, the first unidirectional fiber fabric layers 40 may be made of carbon fiber fabric, while the second unidirectional fiber fabric layers 50 are made of glass fiber fabric. Alternatively, the first unidirectional fiber fabric layers 40 may be made of glass fiber fabric, while the second unidirectional fiber fabric layers 50 are made of carbon fiber fabric. However, if only one first unidirectional fiber fabric layer 40 is placed on the surface of the tubular body 30, it may be susceptible to wear during the manufacturing process. Therefore, a pair of first unidirectional fiber fabric layers 40 may be bonded together on the surface of the tubular body 30, as shown in FIG. 4.

In this embodiment, a damping member 60 is disposed in the front section of the hollow portion 32 of the tubular body 30. The damping member 60 can be made of various plastics with shock-absorbing properties, such as PU foam material with a specific density. This design not only effectively reduces vibration amplitude but also absorbs impact forces and noise.

Furthermore, the outer surface of the tubular body 30 may be covered with a shock-absorbing layer 70, such as a wooden surface layer, to further enhance vibration absorption, reduce energy transmission and noise generation, and ultimately improve the user's stroke feel and overall playing experience.

To accommodate varied user preferences for the cue's weight and balance while also enhancing stability and energy transfer during shots, the present invention features an easily adjustable weight system that enables precise center-of-gravity adjustments. In this embodiment, a weight adjustment system 80 is positioned inside the rear hollow section 34 of the tubular body 30 and includes a tubular member 82 and at least one weight device 84. The tubular member 82 is made of a machinable plastic material, such as ABS, which is lightweight and highly durable, and is securely fixed inside the rear hollow section 34. The inner wall of the tubular member 82 is provided with an internally threaded surface 820 to facilitate precise engagement with the weight device 84. The weight device 84, made of metal or other rigid materials, features an externally threaded surface 842 that mates with the internally threaded surface 820 of the tubular member 82 and is screwed into its interior. For greater adjustability, the length of the tubular member 82 is designed to be greater than that of a single weight device 84, accommodating multiple weight devices 84, which can be screwed in as needed. Generally, the weight devices 84 are available in 7.1 g, 14.2 g, or 28.4 g, enabling users to customize their setup as needed. Additionally, the bumper 22 is screwed onto the rear end of the tubular member 82 via a threaded section 220.

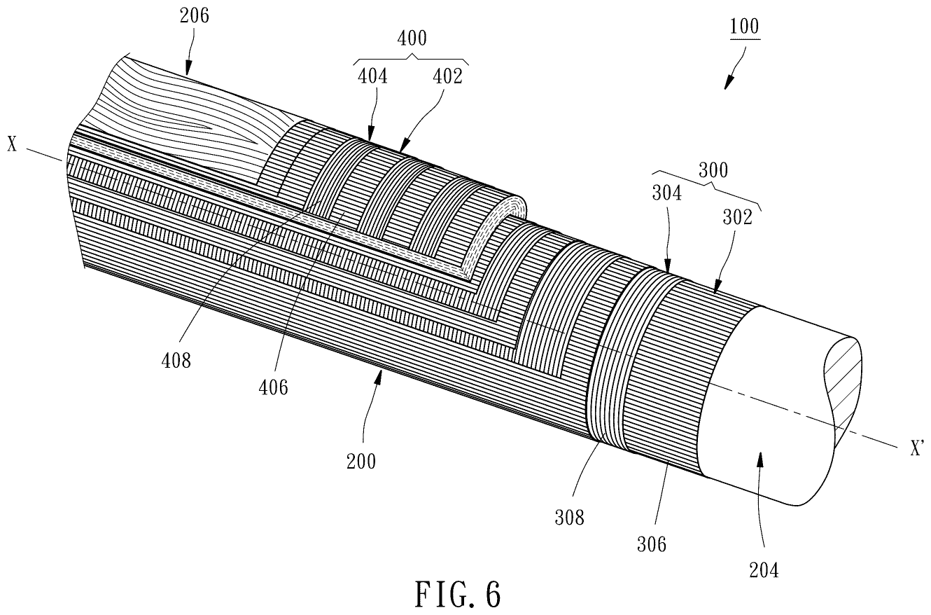

Next, refer to FIG. 6, which illustrates a partial sectional perspective view of another preferred embodiment of a butt 100 for a billiard cue according to the present disclosure. To provide a softer impact sensation, reduce high-frequency vibrations, and enhance feedback during striking—while maintaining a balance between performance and manufacturing costs—the butt 100 includes a tubular body 200. The tubular body 200 comprises a lower fiber fabric layer region 300 located near its central axis, adjacent to a damping member 204 made of a PU foam material, and an upper fiber fabric layer region 400 located near its surface, adjacent to a shock-absorbing layer 206 made of a wooden material. The lower fiber fabric layer region 300 includes a plurality of first unidirectional fiber fabric layers 302 and a plurality of second unidirectional fiber fabric layers 304, both of which are made of unidirectional carbon fiber fabric. Each first unidirectional fiber fabric layer 302 has multiple fibers 306 oriented parallel to the axis X-X′. Each second unidirectional fiber fabric layer 304 has multiple fibers 308 oriented perpendicular to the axis X-X′. The upper fiber fabric layer region 400 includes a plurality of first unidirectional fiber fabric layers 402 and a plurality of second unidirectional fiber fabric layers 404, both of which are made of unidirectional glass fiber fabric. Each first unidirectional fiber fabric layer 402 has multiple fibers 406 oriented parallel to the axis X-X′. Each second unidirectional fiber fabric layer 404 has multiple fibers 408 oriented perpendicular to the axis X-X′. Alternatively, the lower fiber fabric layer region 300 may be made of unidirectional glass fiber fabric, while the upper region 400 is made of unidirectional carbon fiber fabric.

What is claimed is:

1. A butt of a billiard cue, comprising:
a fiber-reinforced plastic tubular body including:
a hollow core defining a central axis along its length;
at least a first unidirectional fiber fabric layer for transmitting force along the axis; and
at least a second unidirectional fiber fabric layer bonded to the first unidirectional fiber fabric layer to prevent shifting during manufacturing;
a damping member installed in the hollow core;
a weight adjustment system including:
a tubular member disposed in the hollow core;
at least a weight device installed inside the tubular member; and
a shock-absorbing layer disposed on the surface of the tubular body.

2. The butt of a billiard cue of claim 1, wherein the first unidirectional fiber fabric layer includes a plurality of fibers extending in a direction parallel to the axis.

3. The butt of a billiard cue of claim 2, wherein the second unidirectional fiber fabric layer includes a plurality of fibers extending in a direction perpendicular to the axis.

4. The butt of a billiard cue of claim 1, wherein both the first and second unidirectional fiber fabric layers are made of carbon fiber fabric.

5. The butt of a billiard cue of claim 1, wherein both the first and second unidirectional fiber fabric layers are made of glass fiber fabric.

6. The butt of a billiard cue of claim 1, wherein the first unidirectional fiber fabric layer is made of carbon fiber fabric and the second unidirectional fiber fabric layer is made of glass fiber fabric.

7. The butt of a billiard cue of claim 1, wherein the first unidirectional fiber fabric layer is made of glass fiber fabric and the second unidirectional fiber fabric layers is made of carbon fiber fabric.

8. The butt of a billiard cue of claim 1, wherein the surface of the tubular body Includes a pair of first unidirectional fiber fabric layers bonded together.

9. The butt of a billiard cue of claim 1, wherein the tubular body further comprises:
a lower fiber fabric layer region near its central axis, adjacent to a shock-absorbing layer;
an upper fiber fabric layer region near its surface, adjacent to a damping member;
the lower fiber fabric layer region includes a plurality of first and second unidirectional fiber fabric layers, both made of unidirectional carbon fiber fabric; and
the upper fiber fabric layer region includes a plurality of first and second unidirectional fiber fabric layers, both made of unidirectional glass fiber fabric.

10. The butt of a billiard cue of claim 1, wherein the tubular body further comprises:
a lower fiber fabric layer region near its central axis, adjacent to a shock-absorbing layer;
an upper fiber fabric layer region near its surface, adjacent to a damping member;
the lower fiber fabric layer region includes a plurality of first and second unidirectional fiber fabric layers, both made of unidirectional glass fiber fabric; and
the upper fiber fabric layer region includes a plurality of first and second unidirectional fiber fabric layers, both made of unidirectional carbon fiber fabric.

11. The butt of a billiard cue of claim 1, wherein the tubular member has an internally threaded surface, the weight device has an externally threaded surface to mate with the internally threaded surface of the tubular member and is screwed into its interior.

12. The butt of a billiard cue of claim 11, wherein the length of the tubular member is greater than that of the weight device.
